(19) United States
(12) Patent Application Publication
(10) Pub. No.: US 2009/0262182 A1
(43) Pub. Date: Oct. 22, 2009

(54) THREE-DIMENSIONAL IMAGING APPARATUS

(75) Inventors: Bahram Javidi, Storrs, CT (US); Manuel Martinez-Corral, Betera (ES); Raul Martinez-Cuenca, Torrente (ES); Genaro Saavedra-Tortosa, Manises (ES)

Correspondence Address: CANTOR COLBURN, LLP, 20 Church Street, 22nd Floor, Hartford, CT, 06103, US

(73) Assignees: THE UNIVERSITY OF CONNECTICUT, Farmington, CT (US); THE UNIVERSITY OF VALENCIA, Valencia (ES)

(21) Appl. No.: 12/251,966

(22) Filed: Oct. 15, 2008

Related U.S. Application Data
(60) Provisional application No. 60/980,105, filed on Oct. 15, 2007.

(51) Int. Cl. H04N 13/02; G02B 13/22; G02B 27/12

(52) U.S. Cl. 348/46; 359/663; 359/626; 348/E13.074

(57) ABSTRACT

A three-dimensional imaging apparatus for imaging a three-dimensional object may include a microlens array, a sensor device, and a telecentric relay system positioned between the microlens array and the sensor device. A telecentric relay system may include a field lens and a macro objective that may include a macro lens and an aperture stop. A method of imaging a three-dimensional object may include providing a three-dimensional imaging apparatus including a microlens array, a sensor device, and a telecentric relay system positioned between the microlens array and the sensor device; and generating a plurality of elemental images on the sensor device, wherein each of the plurality of elemental images has a different perspective of the three-dimensional object.

### CROSS REFERENCE TO RELATED APPLICATIONS

This application claims priority to U.S. provisional application, 60/980,105, filed Oct. 15, 2007, the entire contents of which are incorporated herein by reference.

### FIELD OF THE INVENTION

At least an embodiment of the present invention may relate to devices for imaging a three-dimensional object.

### BACKGROUND OF THE INVENTION

Three-dimensional (3D) image recording and visualization have been subjects of great interest. Among the proposed techniques Integral, Imaging (InI) provides autostereoscopic images with full parallax. Based on the principle of Integral Photography, InI has become a promising procedure to produce real-time 3D imaging (see, e.g., Okano et al., “Real time pickup method for a three-dimensional image based on internal pohotography,” Appl. Opt. 36, 1598-1603 (1997); and Arai et al. “Gradien-index lens-array method based on real-time integral photography for three-dimensional images,” Appl. Opt. 37, 2034-2045 (1998)). In the past few years important research efforts have been addressed to overcome fundamental limitations of InI, such as the limited extension of the depth of field, the enhancement of the viewing angle, the generation of orthoscopic integral images and the improvement of the quality of displayed images. There have been practical advances by designing 2D-3D displays and multiview video architecture and rendering.

Another topic of interest has been the search for procedures and devices for minimizing the overlap between microimages when capturing large 3D scenes. The insertion of opaque barriers, commonly known as optical barriers, could solve this problem. However, the technical implementation of these barriers is very complicated and has been demonstrated only in the display stage and with bigger lenses (see Kim et al. “Wide-viewing-angle integral three-dimensional imaging system by curving a screen and a lens array” Appl. Opt. 44, 546-552 (2005)).

The use of an array of gradient index (GRIN) microlenses to obtain the collection of non-overlapped microimages (as proposed by Okano et al. in “Amplified optical window for three-dimensional images,” Opt. Lett. 31, 1842-1844 (2006)) is more feasible. Note, however, that GRIN lenses have limited performance in non-paraxial imaging, that is, when imaging with large perspective angles. The use of arrays of couplings of two or three convergent lenses can also contribute to reduce the overlapping problem.

There exists another technique for the reduction of overlap between microimages, namely, the use of a relay system. Such a system was originally intended for projecting, with the proper magnification, the microimages onto a sensor (as noted in Okano et al., “Real time pickup method for a three-dimensional image based on internal pohotography,” Appl. Opt. 36, 1598-1603 (1997)). Additionally, the relay system inherently produces a second beneficial effect: a reduction in the overlapping between microimages.

However, this technique suffers from a number of inconvenient drawbacks. First, the microimages recorded during the pickup stage in the charge coupled device (CCD), or any alternative image matrix sensor, do not match the corresponding elemental cells, but are shifted towards the optical axis of the relay system. Also, the microimages are not sharply separated on the recording plane, so that each microimage still overlaps with the neighboring ones.

These geometrical distortions lead to undesirable effects in the display stage, like loss of resolution or image distortions. These effects have dramatic consequences on the visual quality of reconstructed 3D images.

Additionally, the microimages are captured with poor depth of field. Thus, out-of-focus parts of the 3D scenes are reconstructed with poor resolution. Also, there is not any efficient way of performing dynamic focusing. Thus, in the pickup stage it is difficult to focus the InI camera at different depths.

Thus, it is desirable to design a new architecture for the pickup setup, which allows the acquisition of a non-overlapped, un-shifted collection of microimages with enhanced depth of field. The cornerstone of this new architecture is the telecentricity of the relay system.

### SUMMARY OF THE INVENTION

At least an embodiment of a three-dimensional imaging apparatus for imaging a three-dimensional object may include a microlens array, a sensor device, and a telecentric relay system positioned between the microlens array and the sensor device.

At least an embodiment of a telecentric relay system may include a field lens and a macro objective that may include a macro lens and an aperture stop.

At least an embodiment of a method of imaging a three-dimensional object may include providing a three-dimensional imaging apparatus including a microlens array, a sensor device, and a telecentric relay system positioned between the microlens array and the sensor device; and generating a plurality of elemental images on the sensor device, wherein each of the plurality of elemental images has a different perspective of the three-dimensional object.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic configuration of pickup and display of an Integral Imaging (InI) system.

FIG. 2 is a schematic of a conventional pickup device of an InI.

FIG. 3 is a schematic of a pickup device according to at least an embodiment of the present invention.

FIG. 4 is a schematic of an experimental setup.

FIG. 5(a) is a set of 2×2 microimages recorded by using a relay system according to at least an embodiment of the present invention.

FIG. 5(b) is the same set of 2×2 microimages as in FIG. 5(a) but recorded by using a conventional relay system.

FIGS. 6(a)-6(af) are microimages obtained by using a telecentric relay system according to at least an embodiment of the present invention.

FIGS. 7(a)-7(af) are microimages obtained by using a conventional relay system.

FIGS. 8(a)-8(ag) are reconstructed images calculated from a set of microimages captured with a telecentric relay and sensor according to at least an embodiment of the present invention.

FIGS. 9(a)-9(ag) are reconstructed images calculated from a set of microimages captured with a conventional relay and sensor.

FIG. 10 is a schematic of a relay system with an apodizing filter according to at least an embodiment of the present invention.

FIG. 11 is a schematic of a relay system with a liquid crystal display according to at least an embodiment of the present invention.

### DETAILED DESCRIPTION OF THE EMBODIMENTS

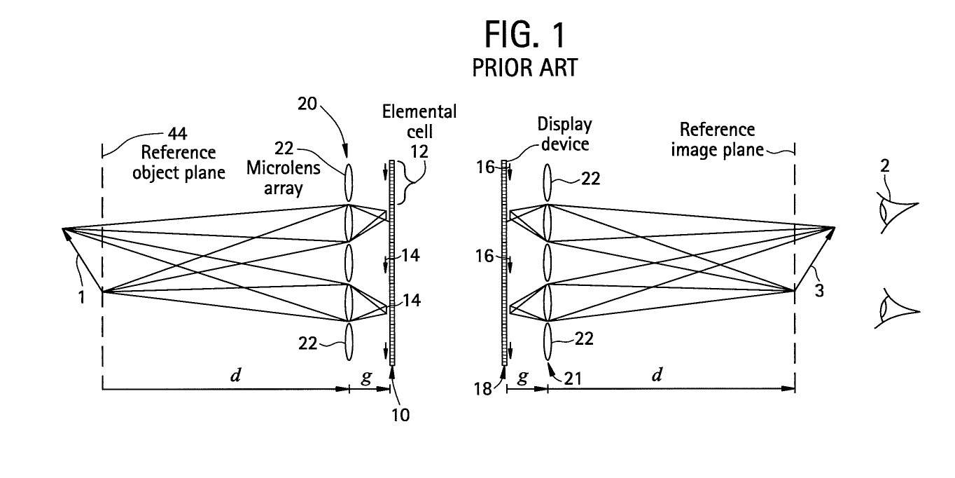

FIG. 1 shows a schematic configuration of an Integral Imaging (InI) system. As seen in FIG. 1, in the pickup stage a collection of elemental images 14, each with different perspective of the 3D scene 1, is generated onto the matrix sensor device 10. In other words, in the pickup stage of an InI system, microlens array 20 generates a collection of 2-dimensional elemental images 14 onto a matrix sensor device 10, such as a charge-coupled device (CCD), a CMOS sensor, or other appropriate device.

In the reconstruction process the recorded elemental images 16 are displayed by a matrix display device 18, such as a liquid crystal display (LCD) or other appropriate device, placed just in front of another microlens array 21. In other words, in the reconstruction stage, the set of recorded elemental images 16 are displayed in front of a second microlens array 21, providing the observer 2 with a reconstructed 3-dimensional image 3.

Although all the elemental images 16 are imaged onto the reference image plane by the corresponding microlenses 22, the 3D image 3 is reconstructed in the image space by the intersection of the ray bundles emanating from each of the microlenses. However, the schematic geometry shown in FIG. 1 cannot be used for real image pickup for at least two reasons.

First, the small size of the matrix sensor device 10 would allow the capture of only few elemental images 14 with small perspective angle. To describe the second problem and the technique for overcoming it, it is necessary to define some nomenclature:

An aerial-image plane 40 is the plane in the image side of the microlens array 20 that is conjugated with the matrix sensor device 10 through the relay system. The conjugate of this plane in the object side of the microlens array 20 is the so-called reference object plane 44.

A microimage 14 is the 2D image of a 3D scene produced by a particular microlens. The size of any microimage is proportional to the transverse size of the 3D scene.

An elemental cell is the region of the aerial-image plane 40 with the same size and position as the corresponding microlens 22. When using a relay system the elemental-cell grid is imaged onto the matrix sensor device 10 with the corresponding scaling.

The Entrance pupil is the conjugate of the aperture stop in the object side of the relay system.

A telecentric relay system is an optical arrangement in which the aperture stop is located in a plane such that its conjugate in the object side (i.e., the entrance pupil) is at infinity.

A micro-entrance pupil is the conjugate of the aperture stop of the relay system in the object side of each microlens.

A micro-window 42 is the region of a given microimage that is actually recorded by the image sensor.

Resolution is defined as the capacity of an image system to provide sharp images of the fine details of the object

Depth of Field (DOF) is the distance by which the object may be axially shifted from the in-focus plane before an unacceptable blur is produced.

Apodization is the modification of the amplitude transmittance of the aperture stop of an imaging system with the aim of engineering its point spread function.

An elemental image is the portion of the microimage that falls within the corresponding elemental cell.

The second problem mentioned above arises from the fact that when capturing large 3D scenes, the different microimages are much larger than the corresponding elemental cells 12, giving rise to a strong overlapping between microimages. In this situation, any elemental cell 12 receives light from many microlenses 22, and therefore no useful information can be extracted from them.

The use of a relay system was proposed for solving the problem resulting from the difference in size between the microlens array 20 and the matrix sensor device 10. However, the relay system only provides a partial solution to the overlapping problem. In practical realizations of In a macro objective 30 is commonly used as the relay system.

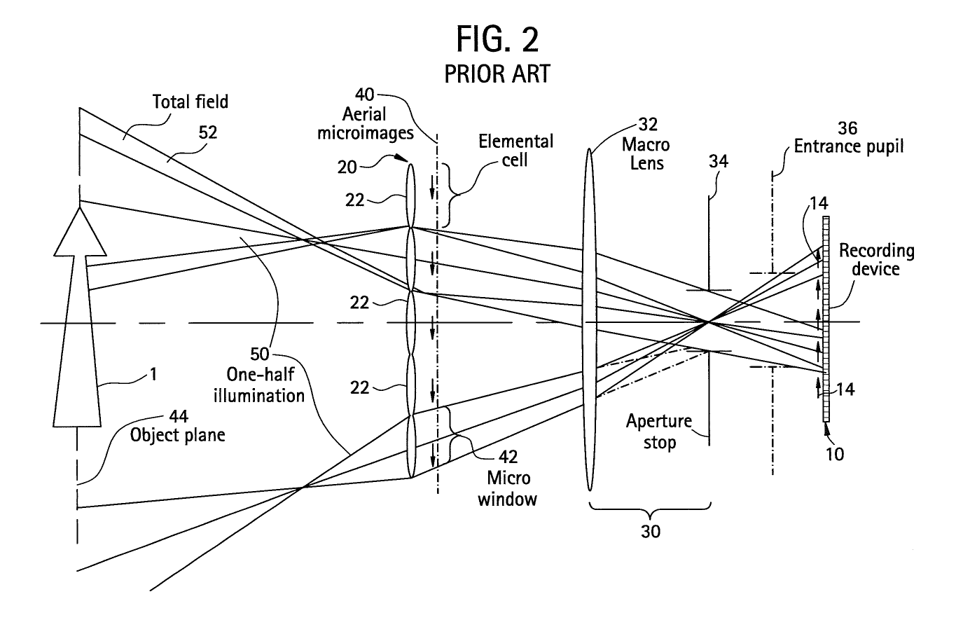

FIG. 2 shows a schematic of a conventional pickup device by means of a microlens array 22 and a macro objective 30 which is composed by a macro lens 32, and an aperture stop 34. In this scheme it is assumed that, in general, the aperture stop 34 is not at the back focal plane of the macro objective 30.

At this stage, the analysis is restricted to the field of at least one-half illumination corresponding to an arbitrary microlens. The one-half illumination bounding rays 50 for such field are rays that pass through the center of the relay-system aperture stop 34 and the edges of a microlens 22. Due to the presence of the relay system, the microlenses 22 no longer provide the image of the whole object scene, but the field of view is limited to a smaller region, which is known as a micro-window 42.

These micro-windows 42 do not match the corresponding elemental cells, but are smaller and shifted towards the optical axis of the macro objective 30. These differences in position and size will be the responsible for important image distortions in the reconstruction stage. Besides, the micro-windows 42 are not sharply separated. To show this, one has to consider the total field of view, which is defined by the total field of view bounding rays 52 passing through the edges of a microlens and the edges of the relay-system aperture stop 34.

There is an important overlapping between neighbor micro-windows 42. This overlapping effect will impoverish the resolution in the reconstructed 3D image.

To allow high-quality 3D reconstructions, the pickup process must be optimized. A pickup architecture that provides a collection of non-overlapped micro-windows 42 whose size and position match the elemental-cell grid is needed.

To obtain this architecture one should realize that: (a) the center of each micro-window 42 is located just at the intersection of the aerial-images plane 40 and the line joining the center of the microlens 22 with the center of the relay-system entrance pupil 36; and (b) the size of each micro-window 42 is determined by joining the center of the relay-system entrance pupil 36 with the edges of the corresponding microlens 22.

Therefore, a relay system 100 in which the entrance pupil 36 of the relay system is placed at infinity allows the micro-windows 42 collection to match the elemental-cells 12 grid. Such arrangement ensures that the conjugate of this entrance pupil 36 through the different microlenses 22, which will be called micro-entrance pupils, is centered just in front of the center of any microlens 22.

In other words, the relay system 100 must be telecentric in its object space and include an aperture stop 34 such that the corresponding micro-entrance pupils are small enough to minimize the overlapping. However, since diffraction effects appear when the micro-entrance pupils are too small, the proper selection of the aperture stop diameter should be the result of the trade-off between the overlapping effect and the diffraction limit.

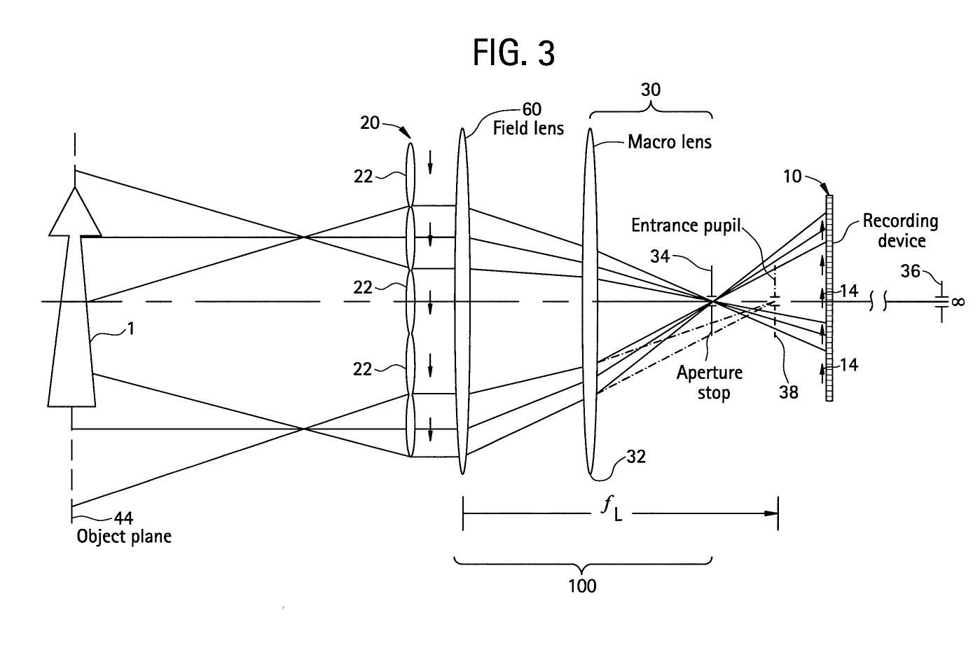

The proposed architecture for the relay system and sensor device is shown in FIG. 3. One embodiment of a telecentric relay system 100 may include a large diameter microlens array 20, the field lens 60, and a macro objective 30 which, as in FIG. 2, is schematized by the macro lens 32 and the aperture stop 34. The macro objective 30 and the field lens 60 should be arranged so that the relay system 100 is telecentric.

In other words, as seen in FIG. 3, the field lens 60, the macro lens 32, and the aperture stop 34 are arranged so that an entrance pupil 36 of the relay system 100 is located at infinity. To make this possible, the entrance pupil 38 of the macro objective 30 (i.e., macro lens 32 and aperture stop 34) has to coincide with the back focal point of the field lens 60.

As shown in FIG. 3, this system permits the capture of a collection of microimages that match the elemental-cell grid. Note that since now the micro-windows have the same size as the elemental cells, the elemental fields of view are wider than the ones obtained with the conventional relay. In other words, this setup permits the acquisition, by optical means, of the correct elemental-image collection.

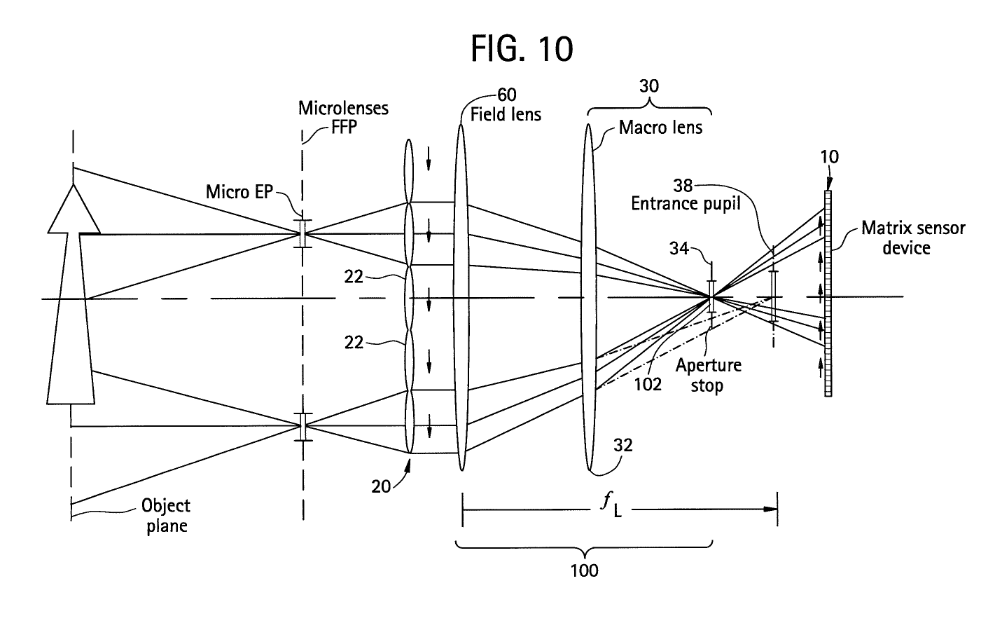

Additionally, a telecentric relay system 100 also permits the easy implementation of parallel apodization of all the microlenses 22. This is because any apodizing filter 102 placed at the aperture stop 34 of the relay system 100 is back-projected onto the front focal plane (FFP) of all the microlenses, as seen in FIG. 10. This simple architecture allows then, for example, the projection onto the microlenses FFP of axially apodizing annular amplitude modulators, thereby improving the depth of field of InI pickup.

In other words, one can project the apodizing annular transmittance simultaneously onto the micro-entrance pupil of any microlens 22. Of course, the utility of parallel apodization is not limited to annular apodization. Any other kind of optical application in which modifications in amplitude and/or phase transmittance of the entrance pupil are needed can be easily implemented by parallel apodization techniques.

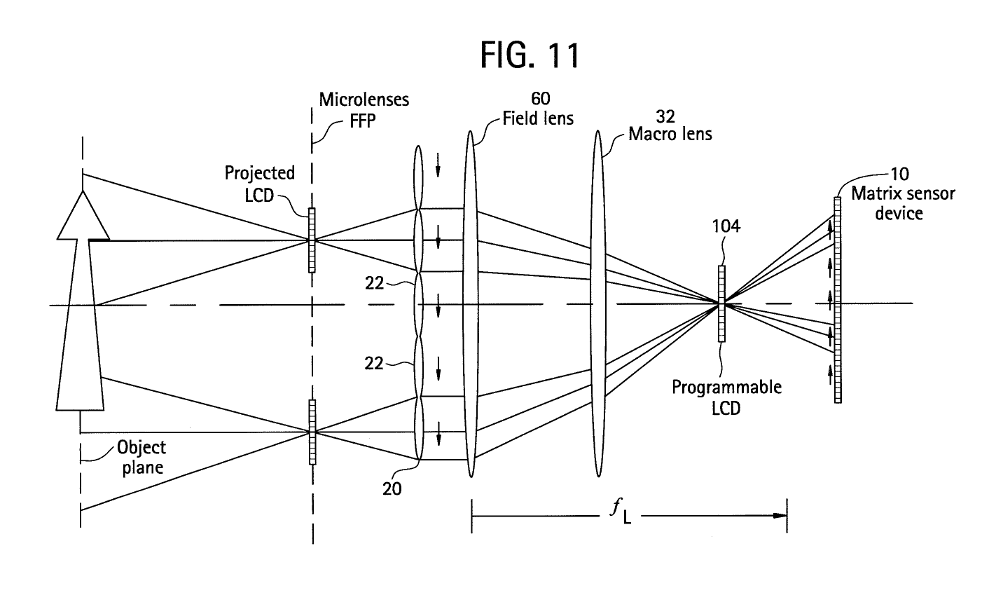

Additionally, the telecentric relay system also permits the parallel modification of the focusing (and therefore of the imaging) properties of the microlenses 22. To do this one inserts, as seen in FIG. 11, a programmable liquid-crystal display (LCD) 104, an autofocus liquid lens, a programmable variable-focus liquid lens, or any alternative programmable device. Thus, by inserting the programmable LCD into the aperture stop 34 of the relay system 100 and by programming a parabolic phase transmittance on it, one can gradually modify in parallel the focusing power of all the microlenses 22. One can gradually modify the position of the object reference plane and the lateral magnification of the microimages. In other words, by this technique one can easily implement an array of micro-zoom lenses. In conclusion, the telecentric relay together with the programmable device permits the production of microimages free of any geometrical distortion and with dynamic focusing.

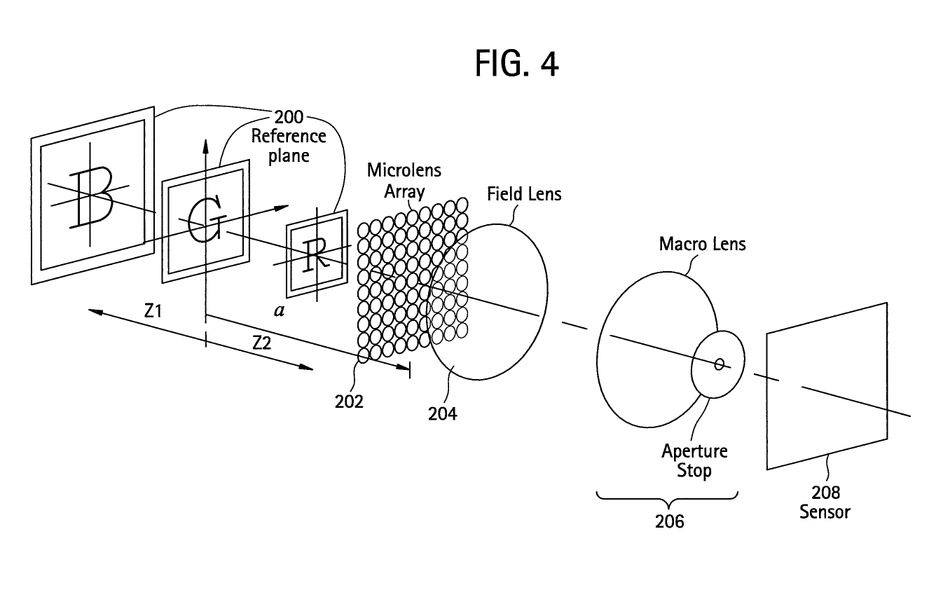

To test the device, hybrid experiments were performed in which the pickup was obtained experimentally in the laboratory, but the reconstruction stage was the result of a computer processing. FIG. 4 shows the layout of the experimental setup.

The 3D scene used in the experiment consisted of three capital letters, namely R, G and B, each printed on a different plate 200, located at different distances from the microlens array. The system was adjusted so that the letter G was in focus. We added a double-line square surrounding each target to make the focusing task easier. The size of the letters was set so that they provide microimages with the same resolution. The targets were illuminated with the white light proceeding from a fiber-optic bundle illuminator.

A microlens array 202 composed of 39×27 square microlenses of 1.01 mm×1.01 mm in size and focal length of ƒ=3.3 mm was used to obtain the microimages. A Canon 60 mm macro objective in combination with an achromatic field lens 204 that is 2 inches in diameter and 200 mm in focal length were arranged to form the telecentric relay. Thus, the distance between the field lens 204 and the macro objective 206 was adjusted so that the back focal plane of the field lens 204 matched the entrance pupil of the macro objective. Specifically the distance was 118 mm. The macro ƒ# was set to 10. The elemental images were recorded onto the color CMOS detector 208 of a Canon EOS 350D camera, consisting of 3456×2304 square pixels in a 22.2×14.8 mm area.

To check the setup's availability to provide non-overlapped microimages, a collection of microimages were registered with the telecentric setup according to at least an embodiment of the present invention, and also with the standard setup in which the field lens is not used.

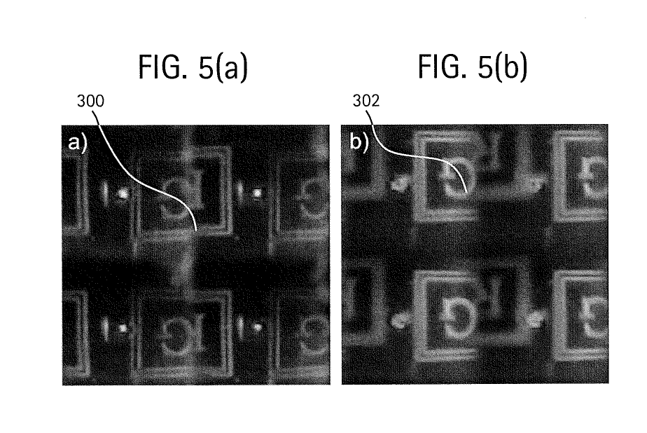

FIGS. 5(a) and 5(b) show a subset of 2×2 micro-images. FIG. 5(a) is obtained using an apparatus in accordance with at least an embodiment of the present invention. FIG. 5(b) was obtained using a conventional apparatus. FIG. 5(b) shows the strong overlapping between microimages provided by the conventional apparatus. The overlapping is clearly minimized with the apparatus according to an embodiment of the present invention setup, as seen in FIG. 5(a).

For example, as seen at reference point 300 of FIG. 5(a), one can see the sharp separation between neighbor microimages, while in FIG. 5(b) the red double-line frame 302 clearly penetrates in the neighbor microimages.

The targets were back-illuminated with a collimated beam proceeding from a He—Ne laser to check if the micro-windows match the elemental cells. Since the laser beam was parallel to the optical axis of the system, every microlens focuses the incoming light onto its own axis. The collection of spots 400 from the laser provided a labeling of the centers of the elemental cells.

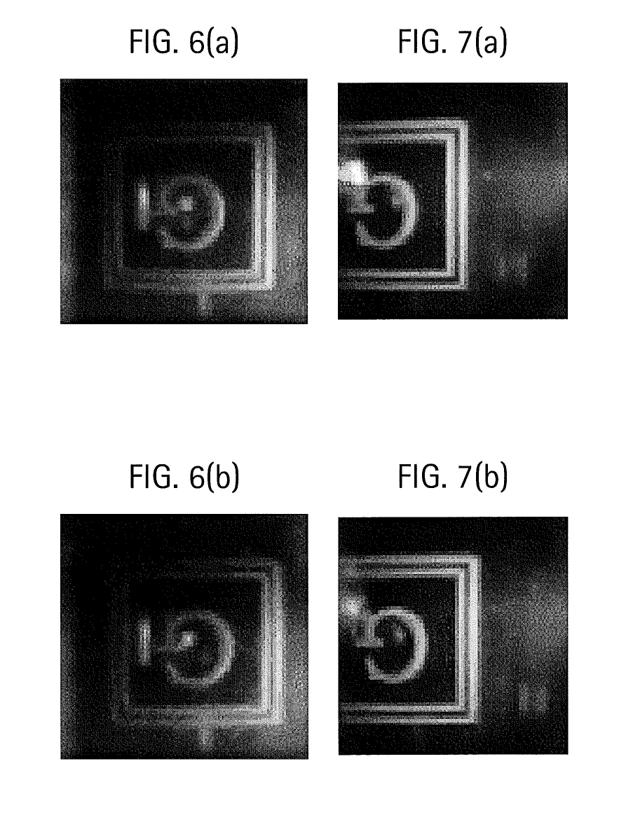

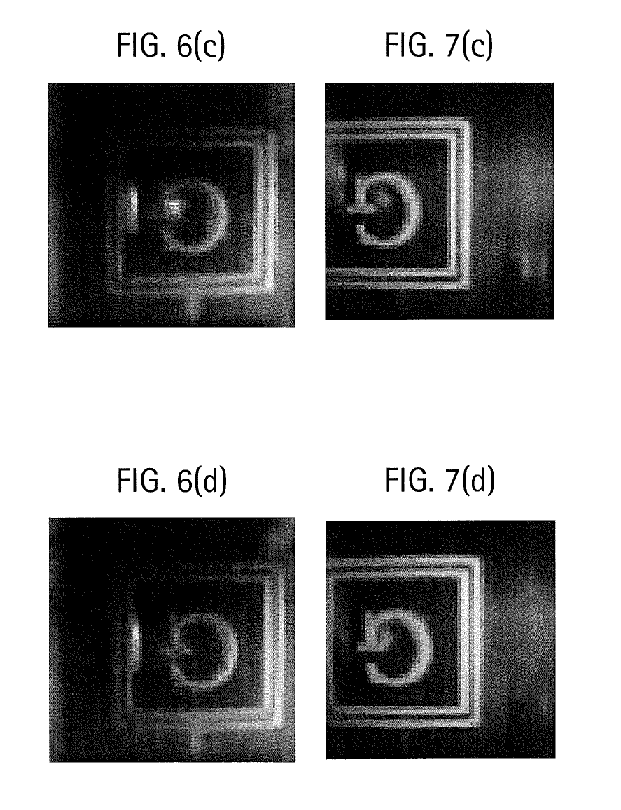

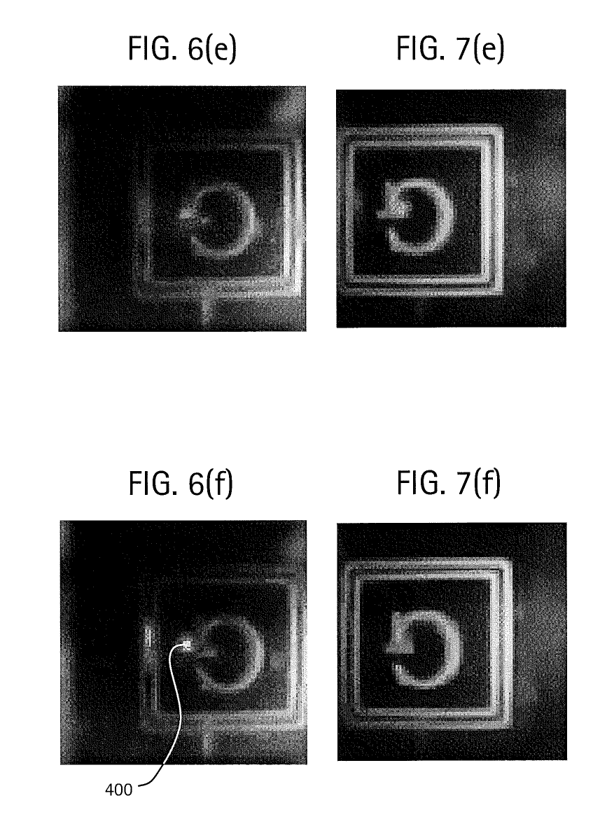

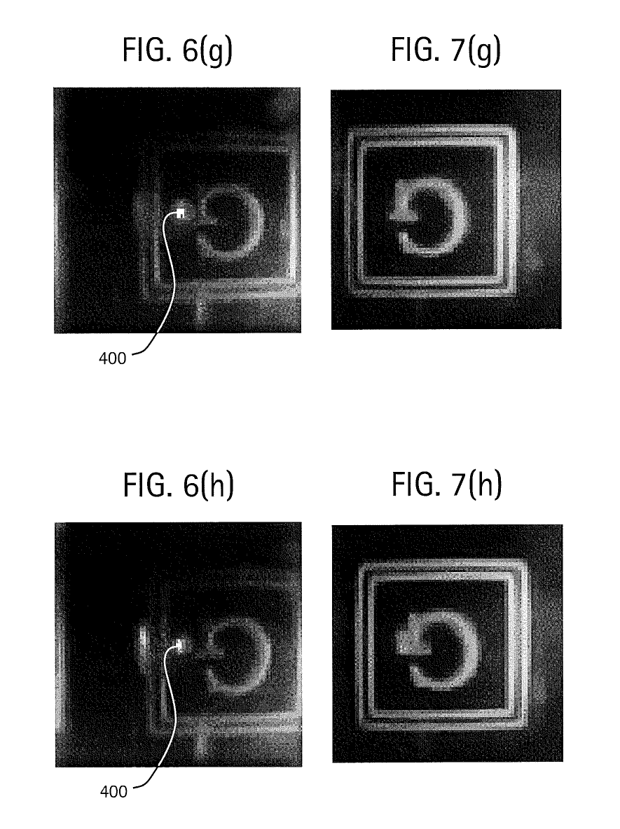

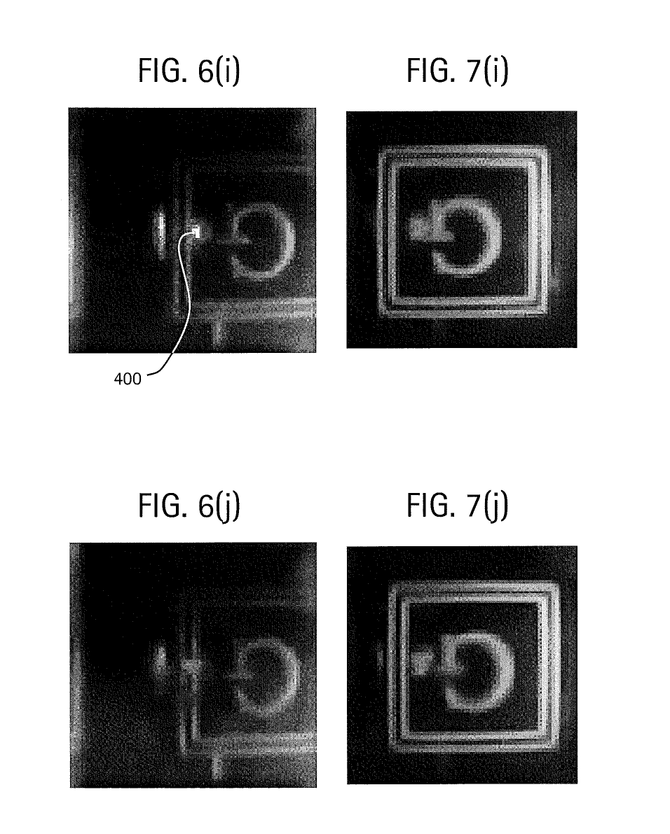

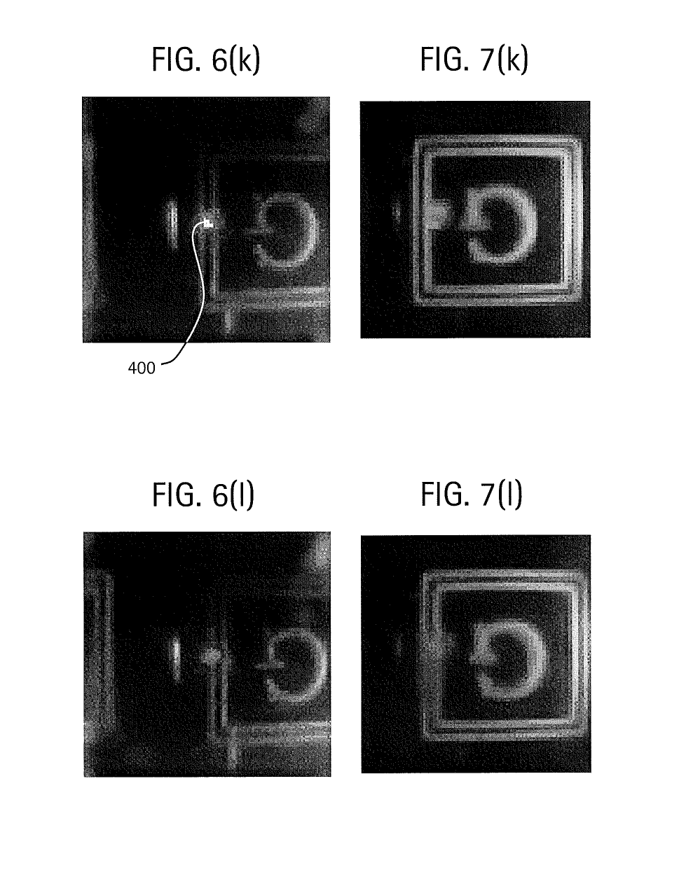

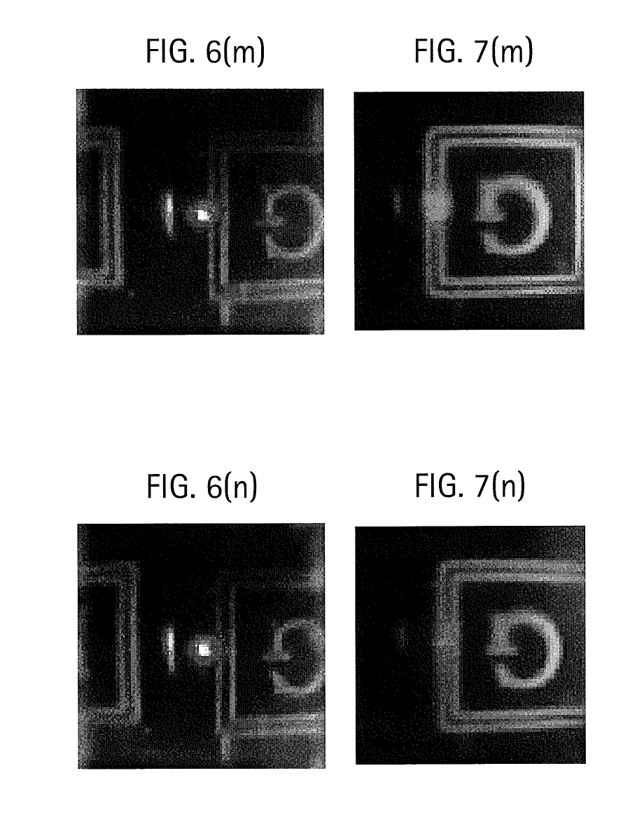

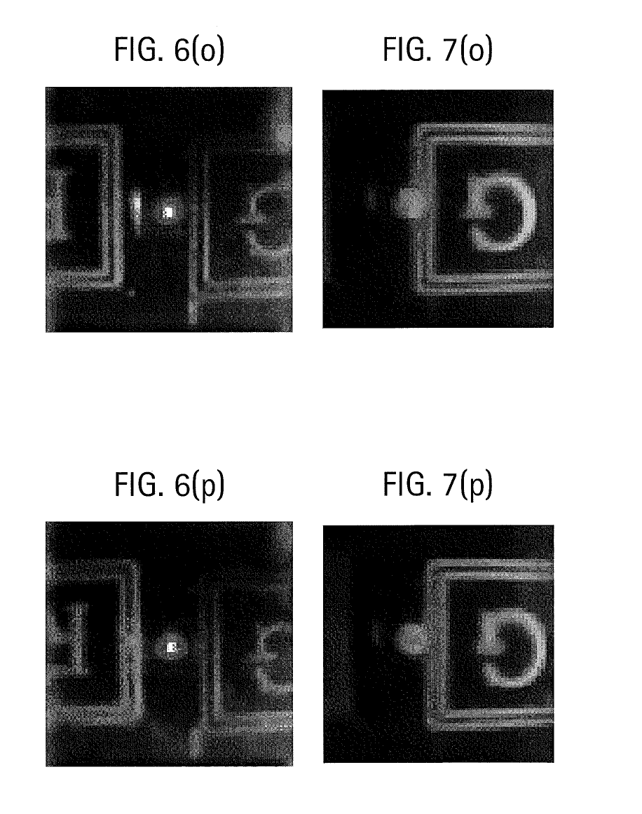

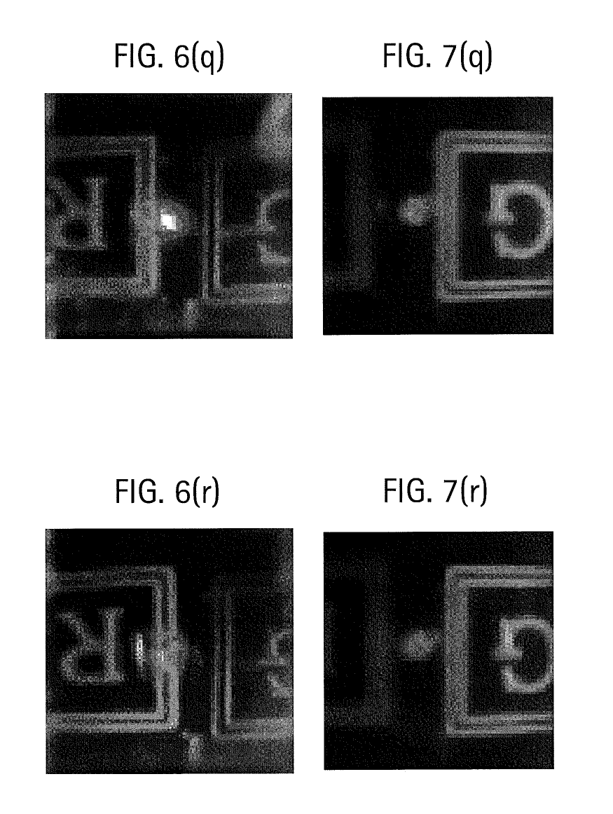

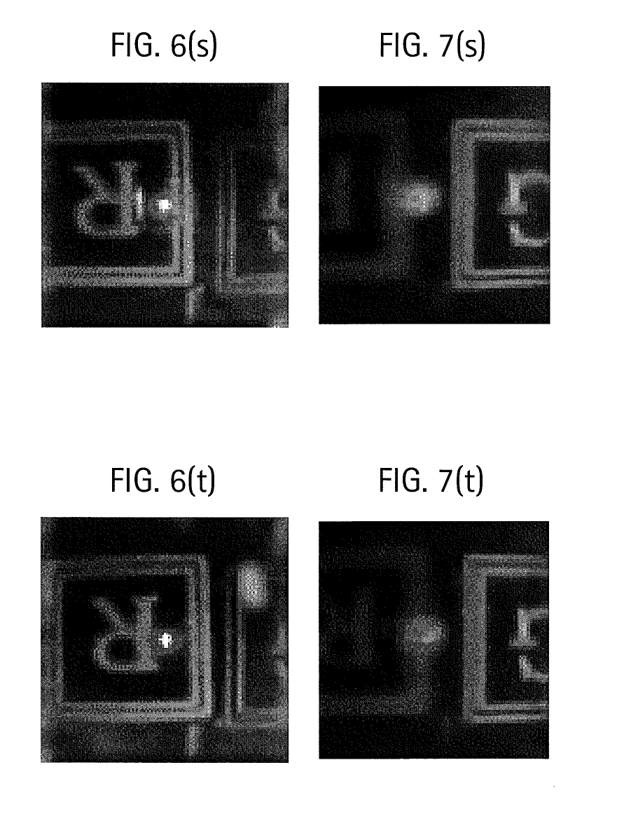

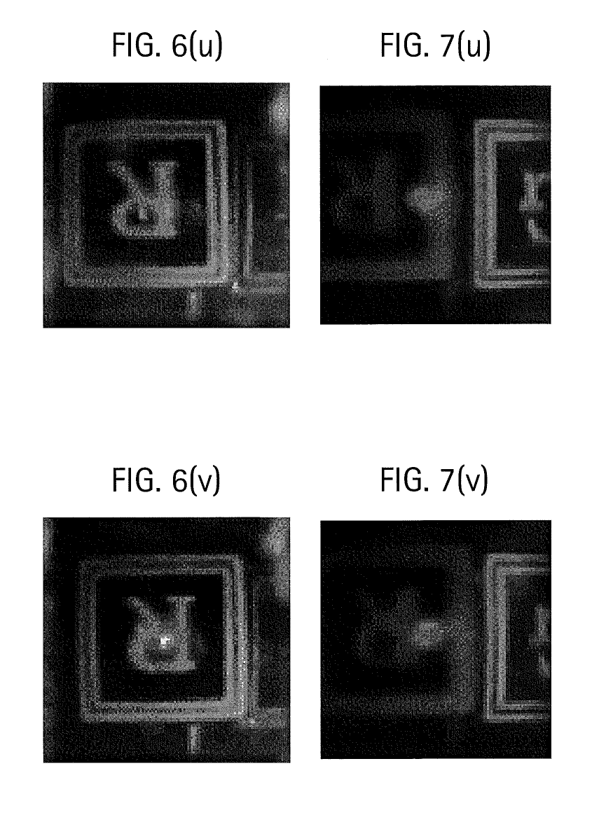

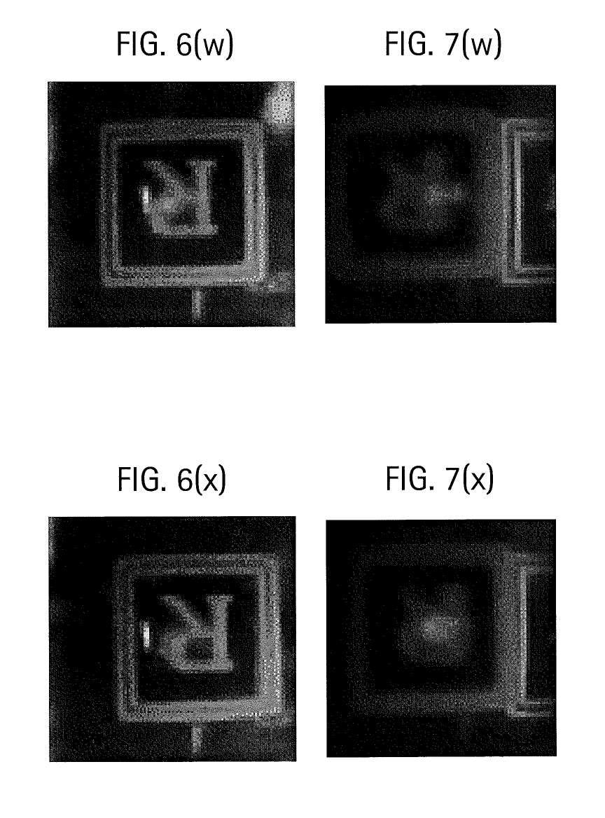

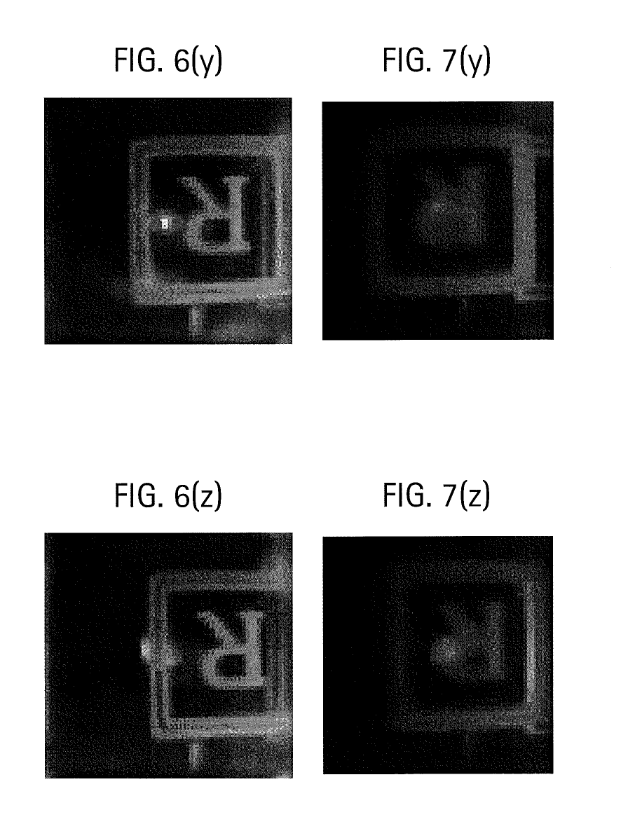

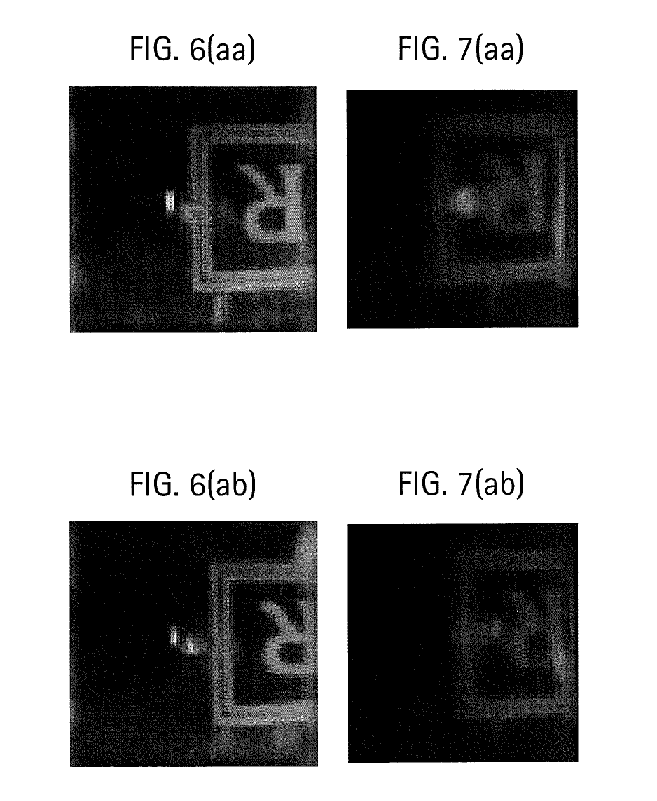

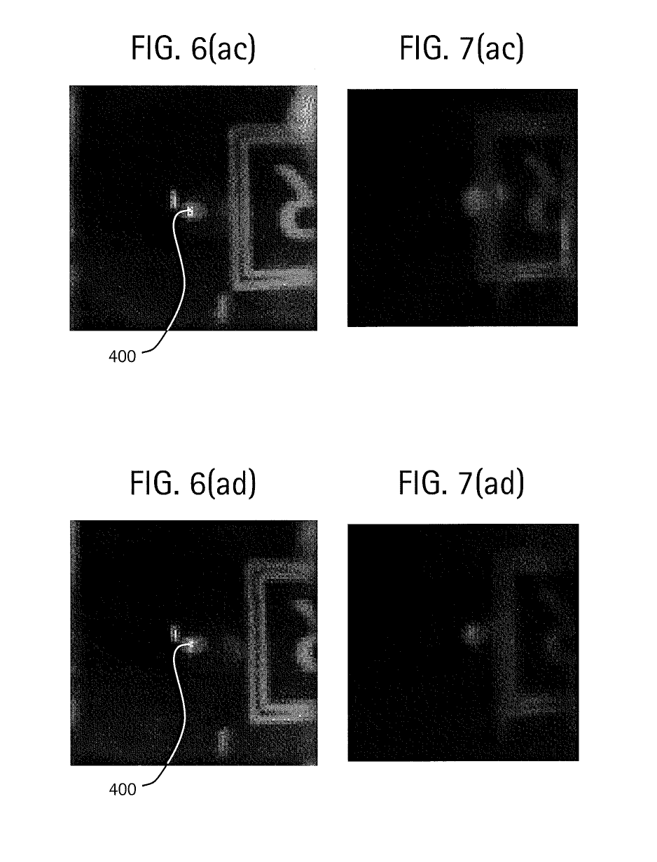

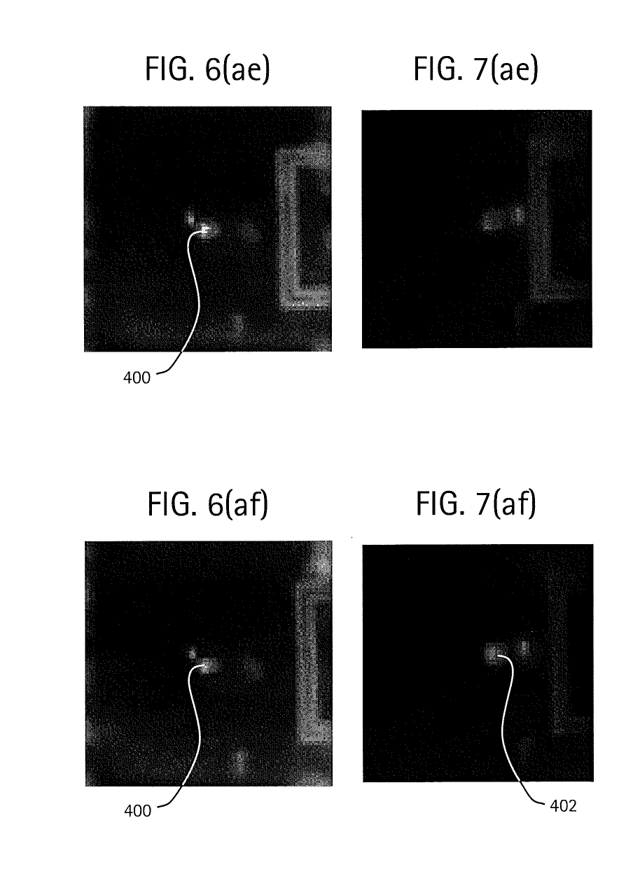

FIGS. 6(a)-6(ag) illustrate microimages registered with an apparatus according to at least an embodiment of the present invention. Note that here the laser spot 400 is always at the center of the elemental cell; good examples are seen in FIGS. 6(f)-6(i), 6(k), 6(m)-6(q), and 6(ac)-6(af). Thus, because the laser spot 400 is at the center of the elemental cell, it is seen that there is no shift between the micro-windows and the elemental cells.

FIGS. 7(a)-7(ag) show microimages registered with a conventional apparatus. In this case, the micro-windows are increasingly displaced, relative to the elemental cells. Specifically micro-windows are displaced towards the optical axis of the macro, and therefore they are no longer centered at the center of the elemental cells.

For example, compare the laser spot 400 in FIG. 6(af) with the laser spot 402 in FIG. 7(af). In FIG. 6(af), the laser spot 400 is in the center of the elemental cell, while in FIG. 7(af), the laser spot 402 is displaced to the right.

The reconstruction stage was simulated. In the calculations it was assumed that the display is done with the same microlens array as in the pickup stage. Since the micro-windows obtained with the conventional relay were smaller than the elemental cells, in the calculations they were magnified so that they matched the elemental cells. As a result of such magnification the resulting microimages using the conventional relay had larger scale than the ones obtained with the telecentric relay.

Each microimage is individually inverted by a 180° rotation. As a consequence of the scaling and the shift suffered by the microimages captured with the conventional relay, the reconstructed images were smaller that the corresponding objects, and therefore smaller than the images reconstructed from the microimages recorded with the telecentric relay.

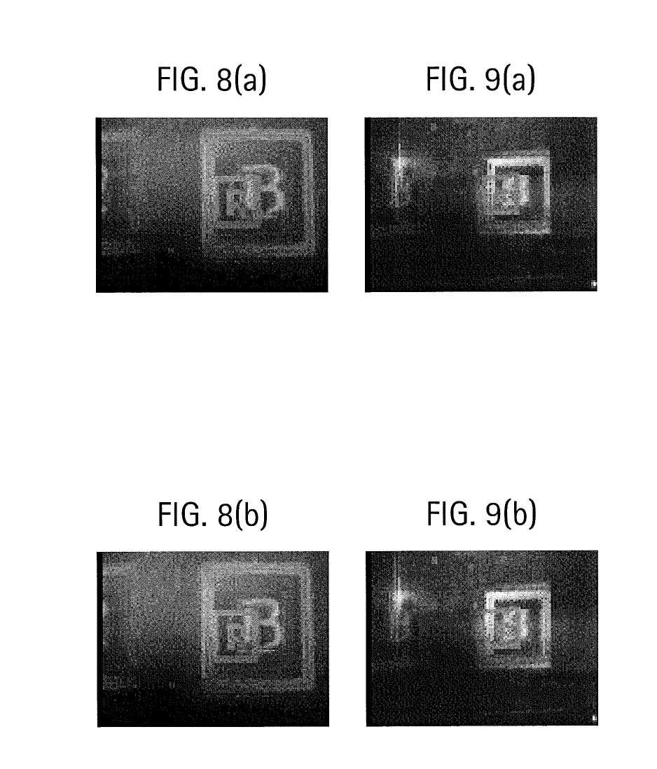

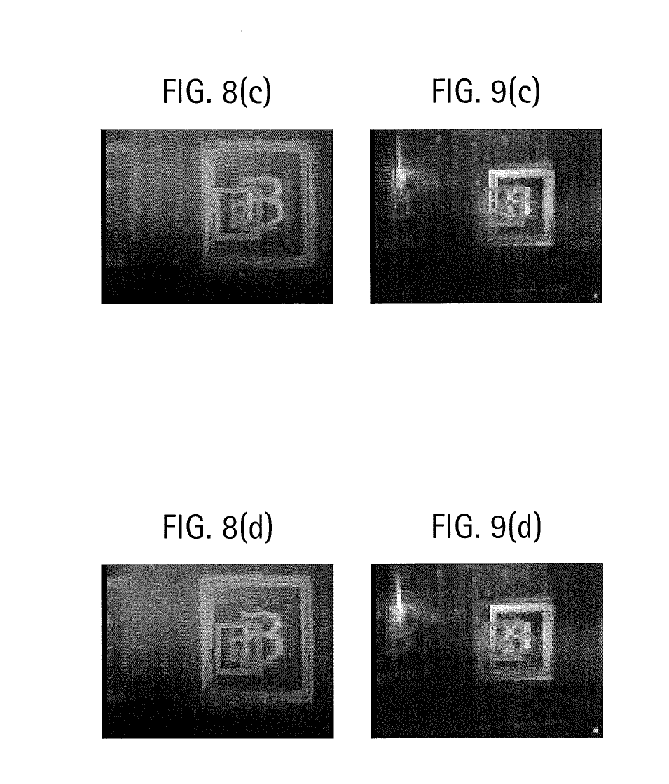

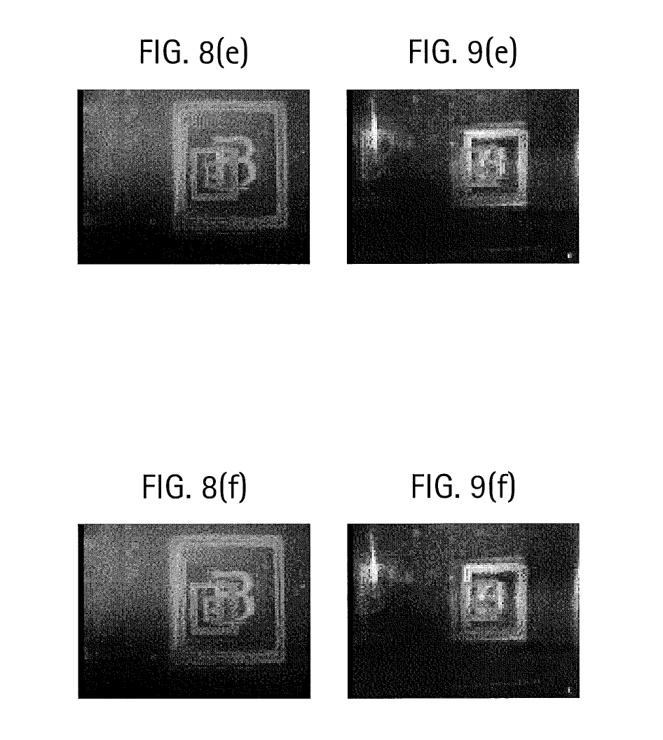

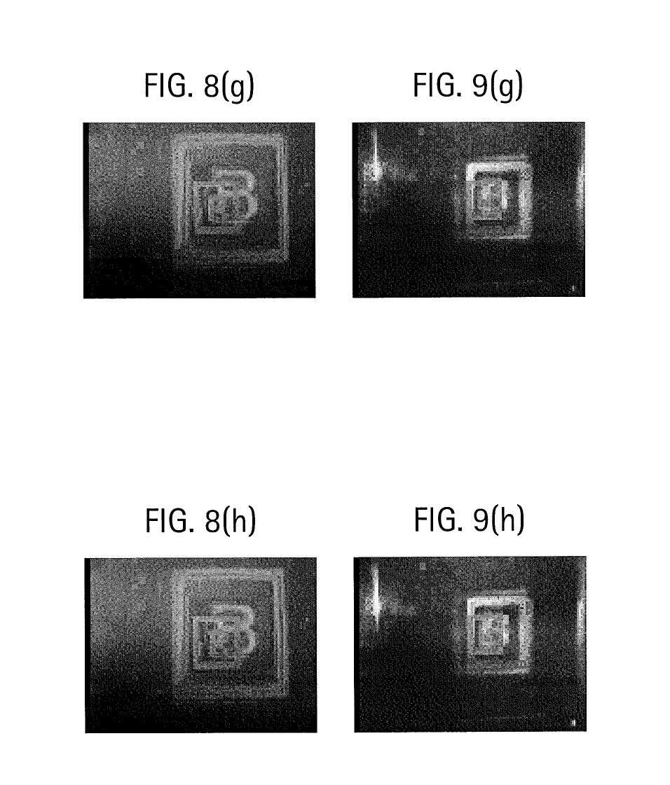

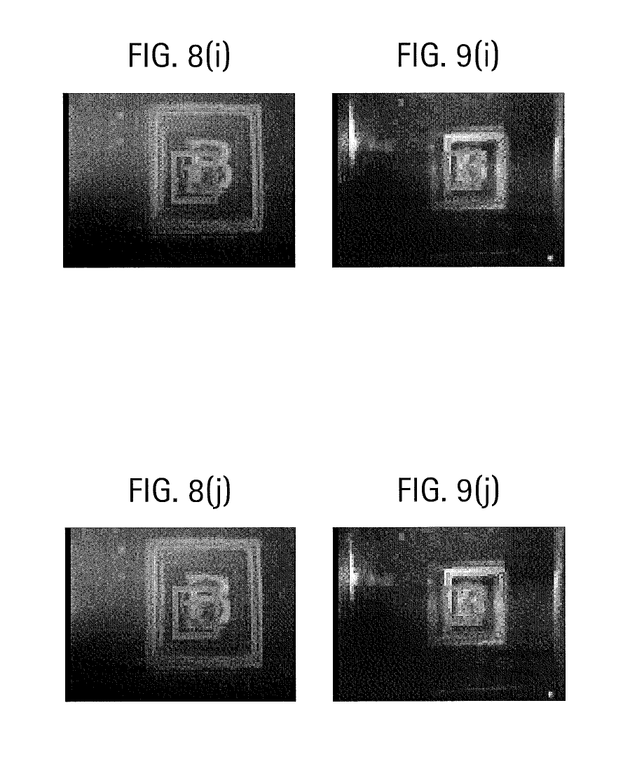

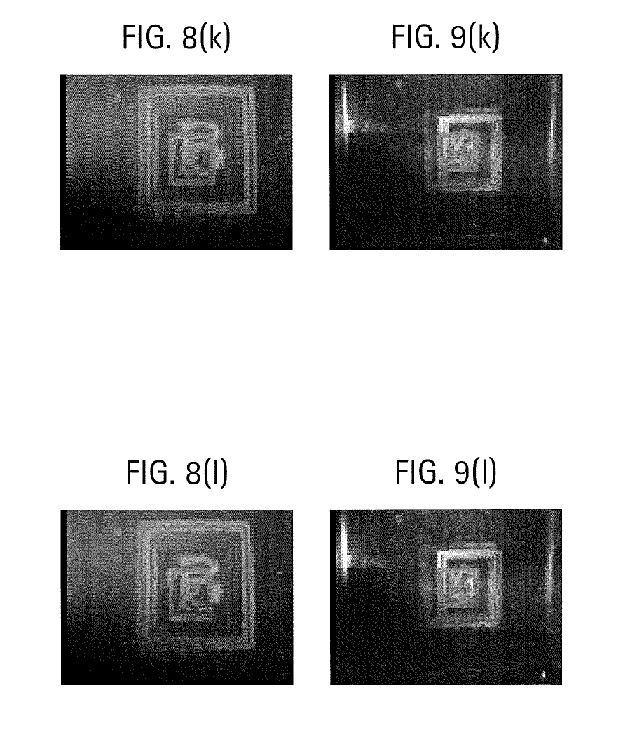

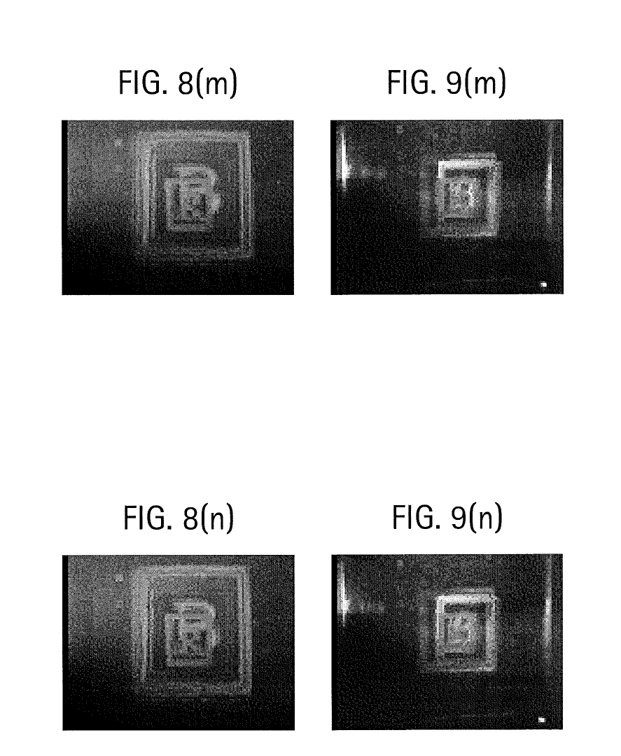

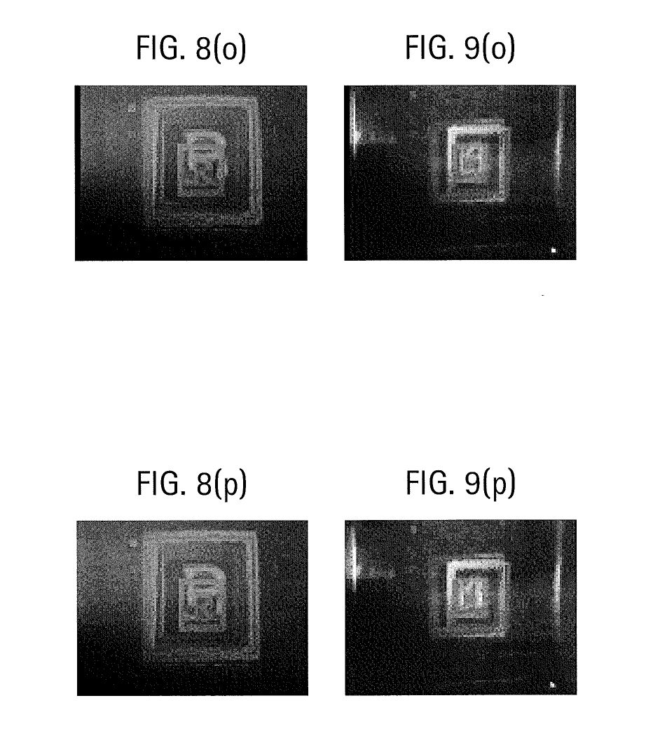

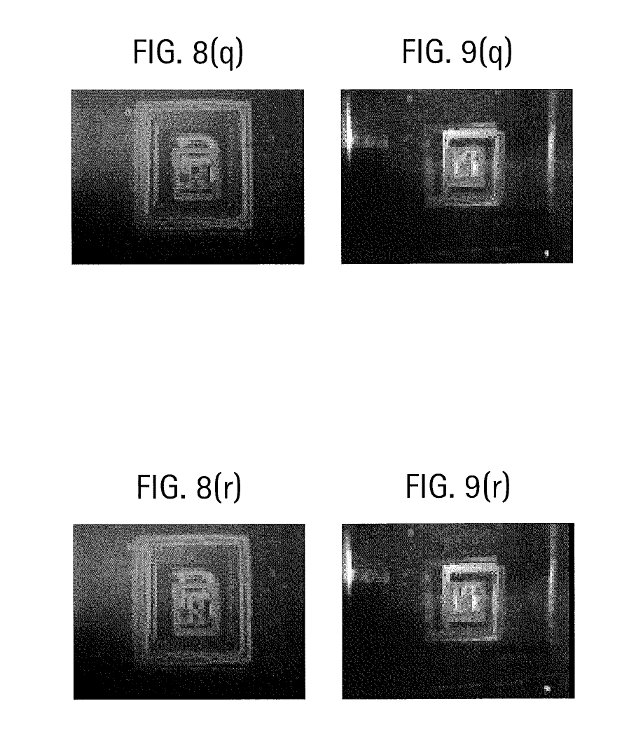

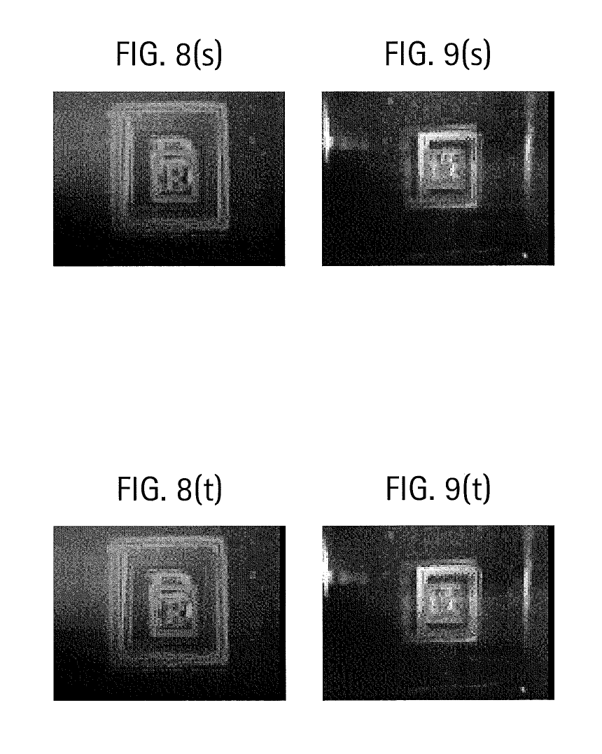

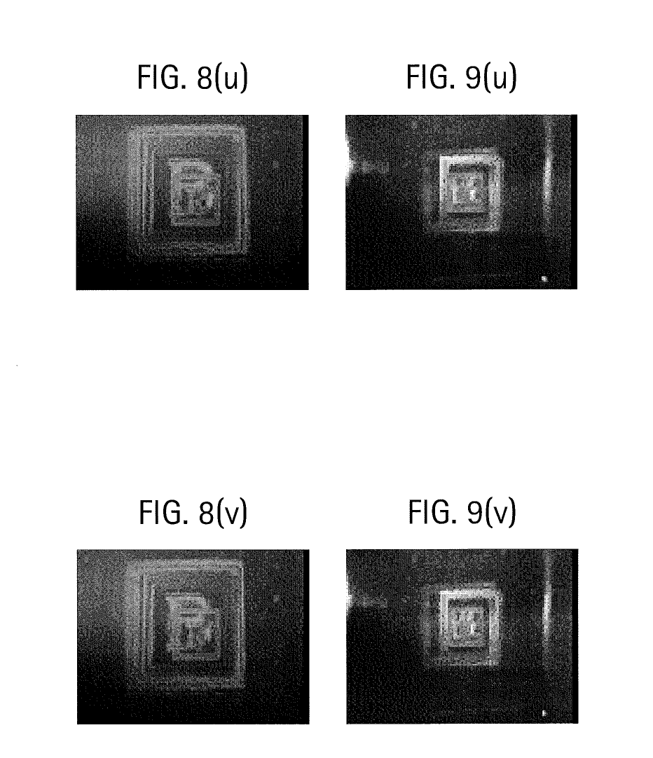

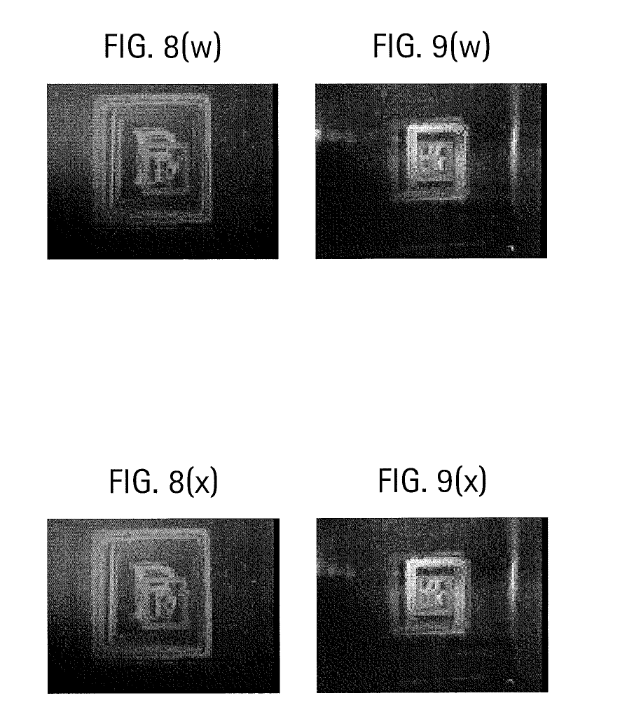

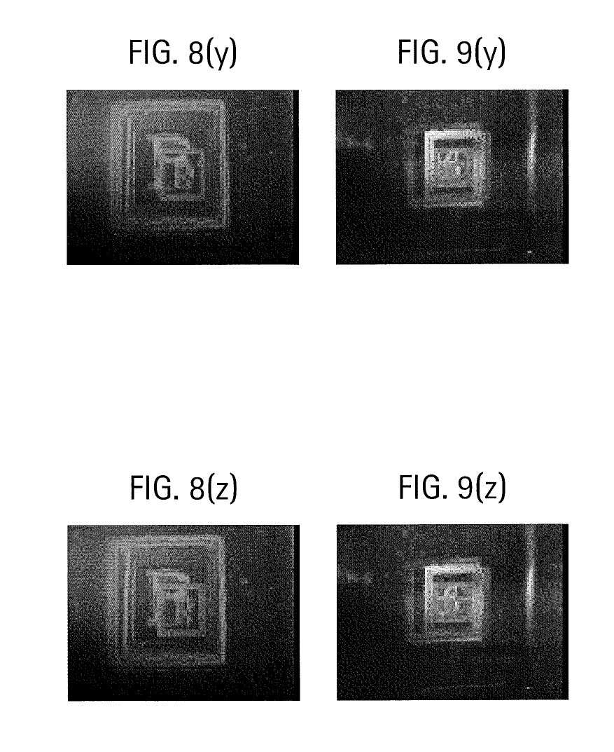

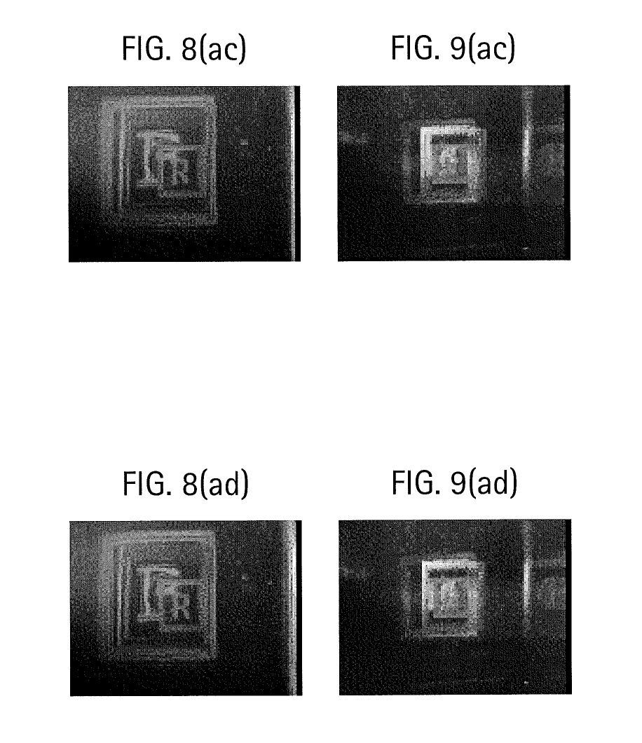

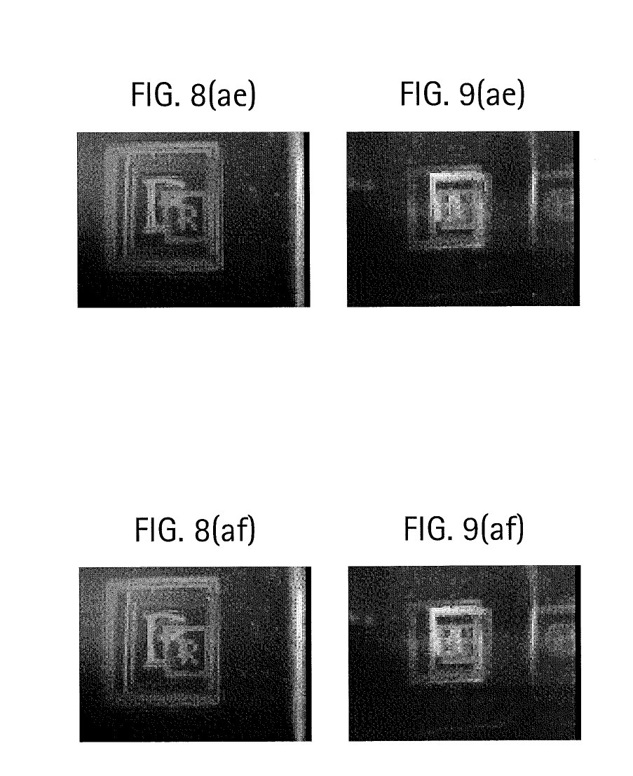

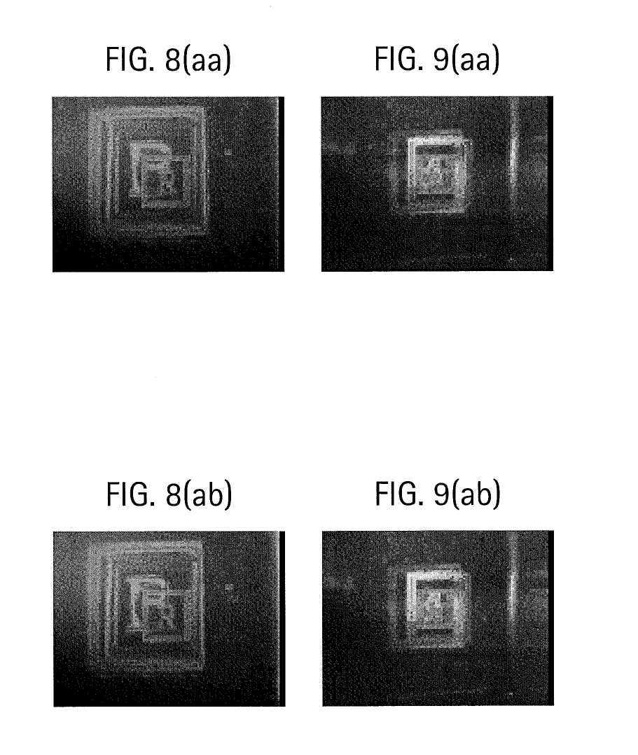

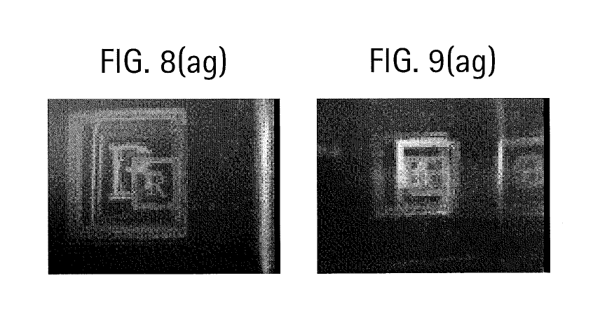

FIGS. 8(a)-8(ag) and 9(a)-9(ag) show the calculated reconstructions. In the calculations it was assumed that an observer is placed at a distance D=400 mm from the microlens array and that displaces laterally from x=−28 mm to x=+28 mm. The position x=0 corresponds to the case in which the observer's eye is centered at the optical axis of the central microlens. From FIGS. 8(a)-8(ag) and 9(a)-9(ag) it is apparent that that the apparatus according to at least an embodiment of the present invention produces reconstructed 3D scenes with much better resolution, without distortions in scale, and with better depth of field when compared to conventional devices.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A three-dimensional imaging apparatus for imaging a three-dimensional object, the imaging apparatus comprising:
a microlens array;
a sensor device; and
a telecentric relay system positioned between the microlens array and the sensor device.

2. The three-dimensional imaging apparatus of claim 1, wherein an entrance pupil of the telecentric relay system is located at infinity.

3. The three-dimensional imaging apparatus of claim 1, wherein the telecentric relay system comprises:
a field lens positioned between the microlens array and the sensor device;
a macro objective positioned between the field lens and the sensor device, the macro objective comprising:
a macro lens positioned between the field lens and the sensor device; and
an aperture stop positioned between the macro lens and the sensor device.

4. The three-dimensional imaging apparatus of claim 3, wherein
the field lens, the macro lens, and the aperture stop are arranged so that an entrance pupil of the telecentric relay system is located at infinity; and
the field lens and the macro lens are arranged so that a back focal plane of the field lens matches an entrance pupil of the macro objective.

5. The three-dimensional imaging apparatus of claim 3, further comprising an apodizing filter inserted at the aperture stop, wherein the apodizing filter is structured to perform parallel apodization.

6. The three-dimensional imaging apparatus of claim 1, further comprising a programmable liquid crystal display, or a programmable variable-focus liquid lens, structured to implement an array of micro-zoom lenses.

7. The three-dimensional imaging apparatus of claim 1, wherein
the microlens array comprises a plurality of microlenses;
the sensor device comprises a plurality of elemental cells; and
each elemental cell has the same size and position as a corresponding microlens in the microlens array.

8. The three-dimensional imaging apparatus of claim 1, wherein the sensor device comprises a charge-coupled device.

9. The three-dimensional imaging apparatus of claim 1, wherein the sensor device comprises a CMOS sensor.

10. A telecentric relay system comprising:
a field lens; and
a macro objective comprising:
a macro lens; and
an aperture stop.

11. The telecentric relay system of claim 10, wherein
the field lens, the macro lens, and the aperture stop are arranged so that an entrance pupil of the telecentric relay system is located at infinity; and
the field lens and the macro lens are arranged so that a back focal plane of the field lens matches an entrance pupil of the macro objective.

12. The telecentric relay system of claim 10, further comprising an apodizing filter inserted at the aperture stop, wherein the apodizing filter is structured to perform parallel apodization.

13. A method of imaging a three-dimensional object, the method comprising:
providing a three-dimensional imaging apparatus comprising:
a microlens array;
a sensor device; and
a telecentric relay system positioned between the microlens array and the sensor device;
generating a plurality of elemental images on the sensor device, wherein each of the plurality of elemental images has a different perspective of the three-dimensional object.

14. The method of claim 13, wherein an entrance pupil of the telecentric relay system is located at infinity.

15. The method of claim 13, wherein the telecentric relay system comprises:
a field lens positioned between the microlens array and the sensor device;
a macro objective positioned between the field lens and the sensor device, the macro objective comprising:
a macro lens positioned between the field lens and the sensor device; and
an aperture stop positioned between the macro lens and the sensor device.

16. The method of claim 15, wherein
the field lens, the macro lens, and the aperture stop are arranged so that an entrance pupil of the telecentric relay system is located at infinity; and
the field lens and the macro lens are arranged so that a back focal plane of the field lens matches an entrance pupil of the macro objective.

17. The method of claim 15, further comprising an apodizing filter inserted at the aperture stop, wherein the apodizing filter is structured to perform parallel apodization.

18. The method of claim 13, wherein the three dimensional imaging apparatus further comprises a programmable liquid crystal display, or a programmable variable-focus liquid lens, structured to implement an array of micro-zoom lenses.

19. The method of claim 13, wherein
the microlens array comprises a plurality of microlenses;
the sensor device comprises a plurality of elemental cells; and
each elemental cell has the same size and position as a corresponding microlens in the microlens array.

20. The method of claim 13, wherein the sensor device comprises a charge-coupled device.

21. The method of claim 13, wherein the sensor device comprises a CMOS sensor.
